(19) United States
(12) Patent Application Publication
(10) Pub. No.: US 2005/0200569 A1
(43) Pub. Date: Sep. 15, 2005

(54) Plasma display panel and energy recovery circuit timing control method thereof

(76) Inventors: Yong-Jin Kim, Suwon-si (KR); Seung-Woo Chang, Suwon-si (KR); Woo-Jin Kim, Suwon-si (KR); Hee-Hwan Kim, Suwon-si (KR)

Correspondence Address: CHRISTIE, PARKER & HALE, LLP, PO BOX 7068, PASADENA, CA, 91109-7068, US

(21) Appl. No.: 11/077,454

(22) Filed: Mar. 9, 2005

(30) Foreign Application Priority Data
Mar. 10, 2004 (KR) 10-2004-0016141

(51) Int. Cl. G09G 3/28

(52) U.S. Cl. 345/60

(57) ABSTRACT

A plasma display panel including a plurality of address electrodes, a plurality of scan electrodes, and a plurality of sustain electrodes, and an energy recovery circuit (ERC) timing control method thereof. The plasma display panel includes a plasma panel, a controller, an address electrode driver, a sustain electrode driver, and a scan electrode driver. A load ratio is determined from an image signal. The ERC timing is determined corresponding to the load ratio or the automatic power control level corresponding to the load ratio. The sustain electrodes and the scan electrodes operate in response to the determined ERC timing.

### CROSS REFERENCE TO RELATED APPLICATION

This application claims priority to and the benefit of Korean Patent Application No. 10-2004-0016141, filed on Mar. 10, 2004, the entire contents of which is incorporated herein by reference.

### BACKGROUND OF THE INVENTION

1. Field of the Invention

The present invention relates to a plasma display panel, and more particularly, to a method for controlling energy recovery circuit (ERC) timing of the plasma display panel.

2. Discussion of the Related Art

Various flat displays such as the liquid crystal display (LCD), the field emission display (FED), and the plasma display panel (PDP) have been developed. The PDP has higher resolution, a higher rate of emission efficiency, and a wider view angle in comparison with other flat panel displays. Accordingly, the PDP is in the spotlight as a display that can be substituted for the conventional cathode ray tube (CRT), especially in the large-sized displays of greater than forty inches.

The PDP is a flat panel display for showing characters or images using plasma generated by gas discharge, and includes more than hundreds of thousands to millions of pixels arranged in a matrix format, in which the number of pixels is determined by the size of the PDP. The PDP is divided into a direct current (DC) PDP and an alternating current (AC) PDP according to applied driving voltage waveforms and the structures of discharge cells.

Electrodes of the DC PDP are exposed in a discharge space and the current flows in the discharge space when a voltage is applied, and therefore it is problematic to provide a resistor for current limitation. However, electrodes of the AC PCP are covered with a dielectric layer, so the currents are limited because of natural formation of capacitance components, and the electrodes are protected from ion impulses in the case of discharging, and therefore a life span of the AC PDP is longer than that of the DC PDP.

FIG. 1 shows a partial perspective view of an AC PDP. Pairs of a scan electrode 4 and a sustain electrode 5 are formed in parallel on a first glass substrate 1, and are covered with a dielectric layer 2 and a protection film 3. A plurality of address electrodes 8 are established on a second glass substrate 6. The address electrodes 8 are covered with an insulator layer 7. Barrier ribs 9 are formed in parallel with the address electrode 8 on the insulator layer 7 between the address electrodes 8. Phosphors 10 are formed on the surface of the insulator layer 7 between the barrier ribs 9 and on the both sides of the barrier ribs 9. The first and second glass substrates 1, 6 are provided to face each other with discharge spaces 11 therebetween so that the scan electrodes 4 and the sustain electrodes 5 may respectively cross the address electrodes 8. A discharge space 11 between the address electrode 8 and a crossing part of a pair of the scan electrode 4 and the sustain electrode 5 forms a discharge cell 12.

FIG. 2 shows a simplified diagram for representing a three-electrode surface discharge configuration of the PDP depicted in FIG. 1. The address electrodes are provided facing and crossing the scan electrodes and the sustain electrodes in the discharge space formed by the barrier ribs. In the configuration, a discharge is generated for forming wall charges for the purpose of selecting pixels between the address electrodes and the scan electrodes, and discharges for displaying an image are repeatedly generated between the scan electrodes and the sustain electrodes for a predetermined time.

The barrier ribs operate not only to form the discharge space, but also to interrupt emitted light when a discharge is generated for the purpose of preventing cross-talk between neighboring cells. A plurality of the unit configurations are formed on the substrate in a matrix format, phosphor is applied in each unit configuration to form a pixel, and the pixels form a PDP. The commercialized PDP represents a desirable color by generating a discharge in each pixel and exciting the phosphors applied in the inner wall of the pixel by ultraviolet rays generated by the discharge.

Intensity of unit light for each sustain pulse is varied according to a load of a screen in the PDP. When a load of a screen is large, current intensity is increased and therefore the voltage drop of a sustain pulse is increased by the resistance of the panel and the circuit. Accordingly, voltage potential is dropped without maintaining the sustain voltage applied from the power source, a potential difference is reduced when a discharge is generated, and therefore the unit light is reduced. When the load is less, the unit light for each sustain pulse is increased because the voltage drop of the sustain pulse is less and a discharge is generated by a potential difference corresponding to the sustain voltage applied from the power source. The reduction of the potential difference of the sustain pulse caused by the voltage drop may cause an erroneous discharge when the load is large.

The discharge state is improved by inducing a hard switching operation by controlling an ERC timing when a sustain pulse is applied to the electrodes of the driving circuit. However, driving temperature is problematically affected by increasing the discharge current by the hard switching operation and applying a maximum sustain pulse when the load is less. When the load is less, gray scale expression is not proper because the unit light is increased and therefore a brightness difference between the neighboring gray scales is increased, and image quality deteriorates because a brightness difference smear is generated by a difference between the unit lights of the sustain pulse according to the load on a boundary of a screen having both a larger screen-load and a lesser screen-load. These problems are a serious concern because the load of the panel and the resistance will be increased when a PDP with a larger screen, higher-brightness, and higher-resolution is developed. Accordingly, the unit light according to the load is controlled by controlling the ERC timing of the driving circuit for the purpose of solving the problem. However, there is a limit to solve the problem because the conventional ERC timing control is controlled by one value.

The problems of the conventional ERC timing control are as follows.

a) Driving Circuit Temperature Stress

The PDP operates by sequentially applying a sustain-discharge pulse generated by applying an LC-resonance and using characteristics of capacitance load. A rising time Tr of the sustain-discharge pulse affects discharge characteristics of the PDP and is externally controlled by a switch on/off timing of the driving circuit.

As can be seen from FIGS. 3A, 3B, 3C and 3D, the size of unit light for each sustain pulse is varied according to a load of a screen in the PDP. When the load of a screen is large as depicted in FIG. 3A, the current intensity is increased and therefore the voltage drop of a sustain pulse is increased by the resistance of the panel and the circuit. Accordingly, potential is dropped without maintaining the sustain voltage applied from the power source, a potential difference is reduced when a discharge is generated, and therefore the unit light is reduced, as seen in FIG. 3B. When the load is less, as seen in FIG. 3C, the unit light for each pulse is increased because the voltage drop of the sustain pulse is less and a discharge is generated by a potential difference corresponding to the sustain voltage applied from the power source, as seen in FIG. 3D. The reduction of the potential difference of the sustain pulse caused by the voltage drop may cause an erroneous discharge when the load is large. As can be seen from FIG. 4, in the discharge characteristics of the PDP, the discharge is properly generated when the rising time of the sustain pulse is short (A) because discharge currents are increased and therefore the wall voltage is increased (i1). However, the discharge condition gets worse when the rising time of the sustain pulse is long (B) because the discharge currents are reduced and therefore the wall voltage is reduced (i2). As can be seen from FIG. 5, according to the characteristics, the discharge state is improved by controlling the ERC timing of the driving circuit, artificially performing a hard-switching operation (Ts1), reducing the rising time (Tr1), and inducing an intensive discharge. However, driving temperature stress is problematically affected by increasing the discharge current by the hard switching operation and applying a maximum sustain pulse when the load is less. A discharge error module improvement is limited when products are manufactured, because the driving temperature stress is problematically increased when the discharge error is improved.

b) Specific Gray Scale Expression Error

There is a tendency to gradually increase a peak brightness as the PDP is developed. As shown in FIG. 6, at a low automatic power control (APC) level, the brightness is high and therefore the brightness difference between the neighboring gray scales is increased when the gray scale is represented. Therefore, the image quality gets worse because a boundary line is displayed on a screen when a moving picture is realized. The brightness difference between the neighboring gray scales is increased because the unit light for each sustain pulse is increased when the APC level is less, that is, the load is less.

The gray scale error APC area caused by the increase of the brightness difference between the neighboring gray scales is shown in FIG. 6.

c) Brightness Difference Smear

As can be seen from FIGS. 7A, 7B and 7C, a line is displayed as a boundary line because the brightness difference is generated by the unit light for each sustain pulse on the boundary between a large screen load part and a lesser screen load part.

### SUMMARY OF THE INVENTION

In accordance with the present invention a PDP and an energy recovery circuit (ERC) timing control method for controlling size of a unit light by controlling ERC timing and controlling a rising time of a sustain pulse is provided. An increase of driving temperature stress, an erroneous gray scale expression and brightness difference smear are avoided.

An embodiment of the present invention includes a PDP having a plurality of address electrodes, a plurality of scan electrodes, and a plurality of sustain electrodes. A controller receives an external image signal and generates a sustain electrode driving signal, a scan electrode driving signal, and an address electrode driving signal. The controller controls ERC timing corresponding to a load ratio of the image signal. An address electrode driver applies a voltage to the address electrodes of the plasma panel according to the address driving signal from the controller. A sustain electrode driver applies a sustain voltage to the sustain electrodes according to the sustain electrode driving signal from the controller. A scan electrode driver applies a scan voltage to the scan electrodes according to the scan electrode driving signal from the controller.

In accordance with an exemplary embodiment of the present invention an ERC timing control method of the PDP is also provided. An image signal is received and a load ratio is determined. An automatic power control level corresponding to the load ratio is determined to control power. The ERC timing corresponding to the load ratio is determined. A sustain electrode driving signal and a scan electrode driving signal-which drives the sustain electrodes and the scan electrodes by the determined ERC timing are generated.

### BRIEF DESCRIPTION OF THE DRAWINGS

FIG. 1 shows a partial perspective view of the AC PDP.

FIG. 2 shows a diagram for representing a three-electrode surface discharge configuration of the PDP of FIG. 1.

FIGS. 3A, 3B, 3C and 3D show diagrams for representing sustain pulses and unit lights according to load characteristics.

FIG. 4 shows a graph for representing discharge current characteristics according to a rising time of the sustain pulse.

FIG. 5 shows a graph for representing light characteristics according to an energy recovery circuit (ERC) timing control.

FIG. 6 shows a graph for representing brightness according to an automatic power control (APC) level.

FIGS. 7A, 7B and 7C show diagrams for representing a brightness difference smear.

FIG. 8 shows a diagram for representing a configuration of a PDP according to an exemplary embodiment of the present invention.

FIG. 9 shows a diagram for representing a configuration of a controller shown in FIG. 8 in more detail.

FIGS. 10A, 10B, 10C and 10D show diagrams for representing waveforms of a sustain pulse according to an exemplary embodiment of the present invention.

FIG. 11 shows a graph for representing brightness according to the APC level according to an exemplary embodiment of the present invention.

### DETAILED DESCRIPTION

Referring now to FIG. 8, the PDP includes a plasma panel 100, a controller 200, an address electrode driver 300, a scan electrode driver 400 (hereinafter, referred to as a Y electrode driver), and a sustain electrode driver 500 (hereinafter, referred to as an X electrode driver).

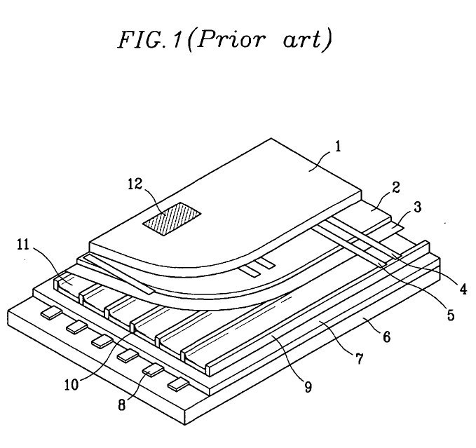

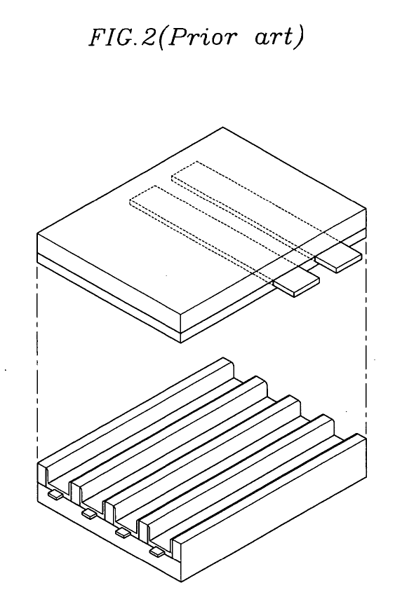

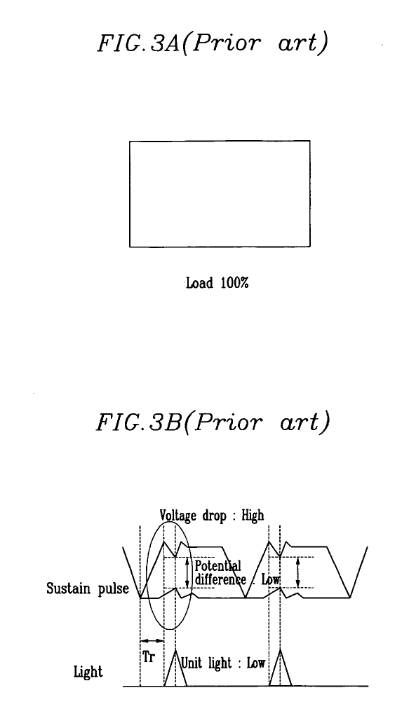

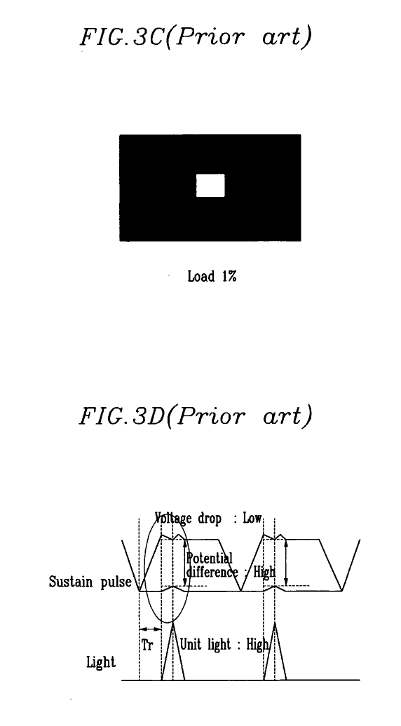

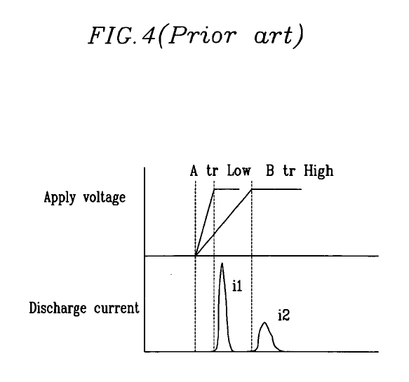

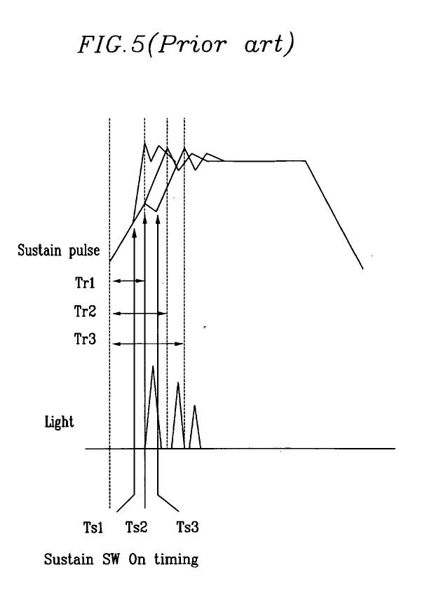

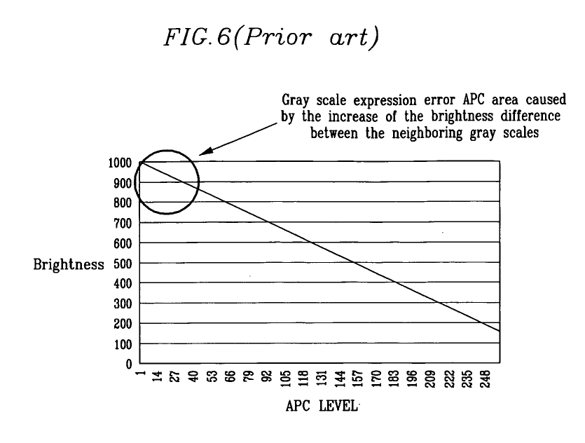

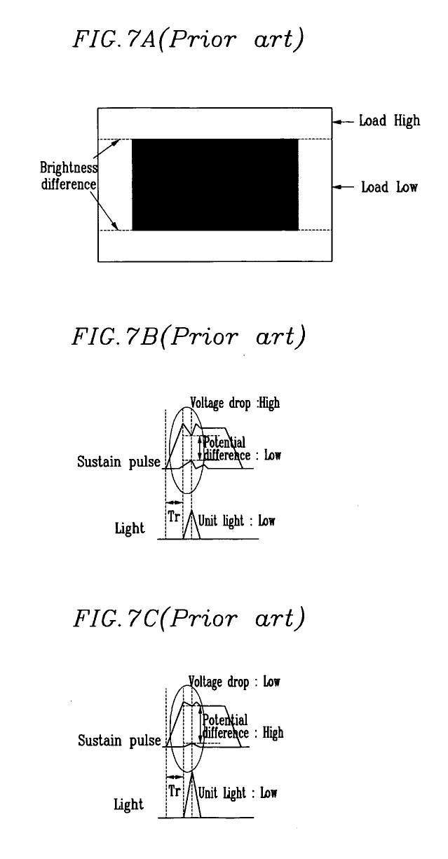

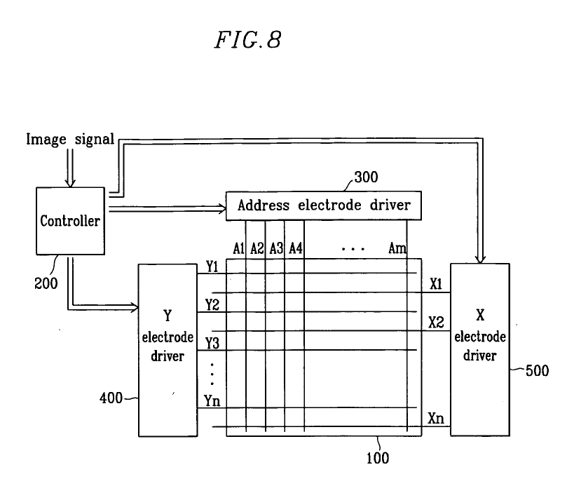

The plasma panel 100 includes a plurality of address electrodes A1 to Am arranged in a column direction, and a plurality of scan electrodes Y1 to Yn and a plurality of sustain electrodes X1 to Xn arranged in a row direction. The X electrodes X1 to Xn are formed corresponding to the Y electrodes Y1 to Yn, and a terminal of each sustain electrode is coupled to the other sustain electrodes in common. The plasma panel 100 includes a glass substrate (not illustrated) on which the X electrodes X1 to Xn and the Y electrodes Y1 to Yn are arranged, and a glass substrate (not illustrated) on which the address electrode A1 to Am are arranged. The two glass substrates are provided to face each other (similar to that shown in FIG. 1) with a discharge spaces therebetween so that the X electrodes X1 to Xn and the Y electrodes Y1 to Yn may respectively cross the address electrodes A1 to Am. Discharge spaces between the address electrodes A1 to Am and a crossing part of the X electrodes X1 to Xn and the Y electrodes Y1 to Yn form discharge cells. The controller 200 divides a frame into a plurality of subfields. The subfields have a reset period, an address period, and a sustain period represented by changes of the operation according to time. Specifically, the controller 200 reduces a brightness difference between neighboring gray scales by calculating a load ratio, controlling a predetermined load ratio or ERC timing in a predetermined APC area, and reducing a quantity of light. The address electrode driver 300 receives an address electrode driving signal from the controller 200, and applies a data signal for selecting a discharge cell to be displayed to the respective address electrodes A1 to Am. The X electrode driver 500 receives an X electrode driving signal from the controller 200 and applies a driving voltage to the X electrodes X1 to Xn. The Y electrode driver receives a Y electrode driving signal from the controller 200 and applies a driving voltage to the Y electrodes Y1 to Yn.

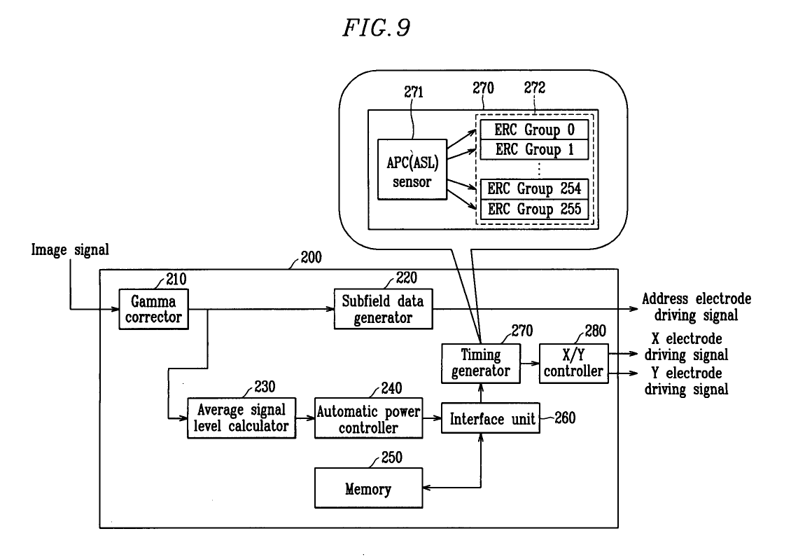

FIG. 9 shows a more detailed diagram of the controller shown in FIG. 8. The controller includes a gamma corrector 210 for receiving an image signal, gamma-correcting the signal, and outputting the signal. An average signal level calculator 230 calculates a load ratio of the gamma-corrected image data. Memory 250 stores the number of sustain pulses corresponding to the load ratio as a look-up table. Automatic power controller 240 determines an APC level corresponding to the load ratio calculated in the average signal level calculator with reference to the memory. Timing generator 270 controls an ERC timing corresponding to the APC level. X/Y controller 280 generates an X electrode driving signal and a Y electrode driving signal with reference to the APC level and the ERC timing. Subfield data generator 220 generates a subfield data from the gamma-corrected image data and outputs the data as an address electrode driving signal. An interface unit 260 acts as an interface between the automatic power controller 240, the memory 250, and the timing generator 270.

An operation of the PDP having the above configuration according to the exemplary embodiment of the present invention will now be described in more detail. The gamma corrector 210 of the controller 200 externally receives an image signal, gamma-corrects the image signal according to the characteristics of the PDP, and outputs the corrected image signal. The subfield data generator 220 generates n subfields from the corrected image signal, and outputs an address electrode driving signal for each subfield. The average signal level calculator 230 calculates a load ratio of the gamma corrected image signal and outputs it. The automatic power controller 240 determines an APC level corresponding to the load ratio according to the memory 250. The timing generator 270 receives the APC level through the interface unit 260 and controls an ERC timing to correspond to the APC level. Specifically, the timing generator 270 controls the ERC timing in a predetermined APC area to reduce an amount of light of the sustain pulse, and therefore, the brightness difference between neighboring gray scales is reduced. As shown in FIG. 9, a memory 272 in the timing generator 270 stores the ERC timing data corresponding to the load ratio or the APC level in a look-up table format or in other formats, and an APC sensor 271 selects corresponding ERC timing data according to the APC level. The data stored in the memory 272 may be determined as an optimal value by experiments. The X/Y controller 280 generates an X electrode driving signal and a Y electrode driving signal with reference to the APC level and the ERC timing. The address electrode driver 300 receives an address electrode driving signal and applies a display data signal for selecting a discharge cell to be displayed to the address electrodes A1 to Am. The X electrode driver 500 receives the X electrode driving signals and applies a driving voltage to the X electrodes X1 to Xn. Y electrode driver 400 receives the Y electrode driving signals and applies the driving voltage to the Y electrodes Y1 to Yn. Data without a brightness difference are displayed on the plasma panel 100.

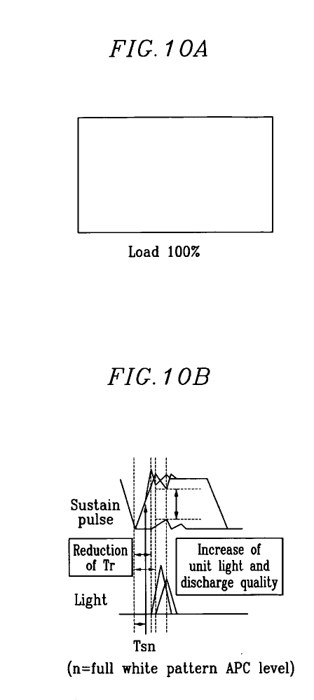

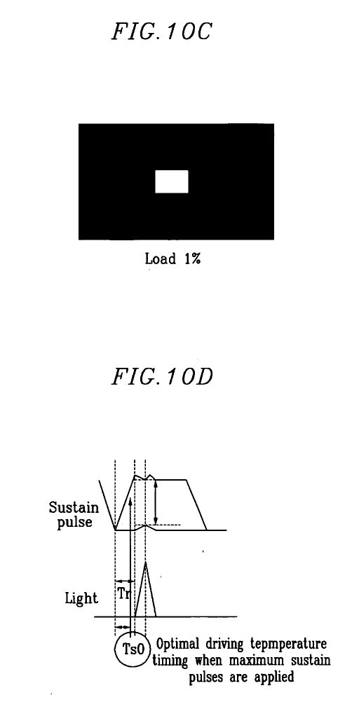

The timing control method will now be described in more detail. As shown in FIG. 10A-10D, temperature stress of the driving circuit is maximized because the number of sustain pulses is maximized when the load ratio is 1%, that is, when the APC level is 0, as a Tsn is controlled and a rising time of the sustain pulse is reduced to improve the discharge quality on a 100% load ratio screen. A Ts0 satisfying a driving temperature is determined, and an optimal Ts according to each load is determined.

While ERC groups may be provided according to the APC levels, it is difficult to control the groups because the number of groups is large and therefore 100 groups or a predetermined number of groups for the respective loads are applied. 32 groups are applied in the exemplary embodiment of the present invention.

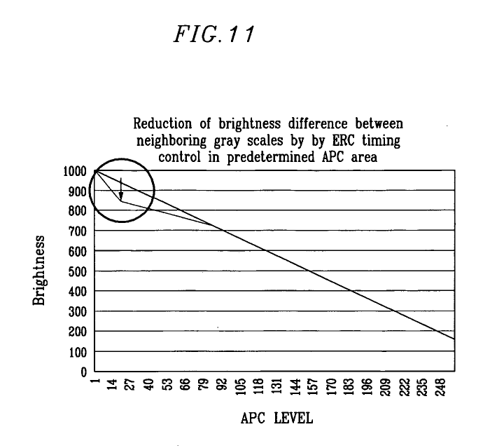

FIG. 11 shows a graph for representing a reduction of the brightness difference between the neighboring gray scales by the ERC timing control for each APC. A failed gray scale expression by an increase of the brightness difference between the neighboring gray scales in the low APC level area is improved by controlling the ERC timing of the predetermined APC level, increasing the rising time of the sustain pulse, and reducing the quantity of light as shown in FIG. 10A-10D.

Also, the brightness difference smear is solved by controlling the ERC timing of the corresponding APC, reducing the quantity of light, and reducing a degree of the difference.

While the rising time of the sustain pulse is controlled according to the APC level to thus control the quantity of light in the exemplary embodiment of the present invention, the rising time of the sustain pulse may be accurately controlled according to the load ratio if necessary.

A detailed description of the modified configurations will be omitted because the timing generator 270 receives a load ratio from the automatic power generator 240 or directly receives a load ratio from the average signal level calculator 230 in FIG. 9, and other configurations are the same.

The APC level is determined by an ASL (average signal level) value. The timing generator 270 transmits the ERC timing value determined by the detected APC level to the X/Y controller 280, and the X/Y controller 280 controls the ERC timing of the X and Y electrode drivers 400 and 500. The load ratio, i.e., the ASL, may be varied on the same APC level and therefore it is effective to control the ERC timing according to the ASL.

As above, the PDP and ERC timing control method having the following effects may be provided in the exemplary embodiment of the present invention.

First, when a 42HD V3 model PDP is developed, a driving temperature stress peak brightness reaches 1000 cd/m² and the driving temperature stress is satisfied at the same time.

Second, the failed gray scale expression by the increase of the brightness difference between the neighboring gray scales is solved, and the failed gray scale expression on a specific screen is solved when the moving picture is realized.

Third, a brightness difference of up to 30 cd/m² is generated when the exemplary embodiment of the present invention is not applied. However, it is reduced to 10 cd/m² when the exemplary embodiment of the present invention is applied.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A plasma display panel comprising:
a plasma panel including a plurality of address electrodes, a plurality of scan electrodes and a plurality of sustain electrodes;
a controller for receiving an external image signal, generating a sustain electrode driving signal, a scan electrode driving signal, and an address electrode driving signal, and controlling an energy recovery circuit timing corresponding to a load ratio of the image signal;
an address electrode driver for applying a voltage to the address electrodes of the plasma panel according to the address driving signal from the controller;
a sustain electrode driver for applying a sustain voltage to the sustain electrodes according to the sustain electrode driving signal from the controller; and
a scan electrode driver for applying a scan voltage to the scan electrodes according to the scan electrode driving signal from the controller.

2. The plasma display panel of claim 1, wherein the controller controls the energy recovery circuit timing to control a rising time of a sustain pulse waveform.

3. The plasma display panel of claim 1, wherein the controller reduces a quantity of light by adjusting the energy recovering circuit timing in a predetermined area where the load ratio is below a predetermined value.

4. The plasma display panel of claim 1, wherein the controller reduces the quantity of light by adjusting the energy recovery circuit timing in a predetermined area where the automatic power control level corresponding to the load ratio is below a predetermined value.

5. The plasma display panel of claim 1, wherein the controller comprises:
a gamma corrector for receiving an image signal, gamma-correcting the image signal, and outputting the image signal;
an average signal level calculator for calculating the load ratio of the gamma corrected image data;
a memory for storing the number of the sustain pulses corresponding to the load ratio as a look-up table;
an automatic power controller for determining the automatic power control level corresponding to the load ratio calculated in the calculator with reference to the memory;
a timing generator for controlling the energy recovery circuit timing corresponding to the load ratio;
an X/Y controller for generating an X electrode driving signal and a Y electrode driving signal with reference to the automatic power control level and the energy recovery circuit timing; and
a subfield data generator for generating the subfield data from the gamma corrected image data and outputting the data as the address electrode driving signal.

6. The plasma display panel of claim 5, further comprising an interface unit interfacing between the automatic power controller, the memory, and the timing generator.

7. The plasma display panel of claim 6, wherein the timing generator reduces the quantity of light by adjusting the energy recovery circuit timing in a predetermined area where the load ratio is below a predetermined value.

8. The plasma display panel of claim 5, wherein the timing generator controls the energy recovery circuit timing corresponding to the automatic power control level determined by the load ratio.

9. The plasma display panel of claim 8, wherein the timing controller reduces the quantity of light by adjusting the energy recovery circuit timing in a predetermined area where the automatic power control level corresponding to the load ratio is below a predetermined value.

10. An energy recovery circuit timing control method of a plasma panel including a plurality of address electrodes, a plurality of scan electrodes, and a plurality of sustain electrodes,
the method comprising:
a) receiving an image signal and determining a load ratio;
b) controlling power by determining an automatic power control level corresponding to the load ratio, and determining energy recovery circuit timing corresponding to the load ratio; and
c) generating a sustain electrode driving signal and a scan electrode driving signal which drives the sustain electrodes and the scan electrodes by the determined energy recovery circuit timing.

11. The energy recovery circuit timing control method of claim 10, wherein controlling power includes increasing a rising time of a sustain pulse waveform for the purpose of reducing a quantity of light and adjusting the energy recovery circuit timing in a predetermined area where the load ratio is below a predetermined value.

12. The energy recovery circuit timing control method of claim of claim 10, wherein controlling power includes controlling the energy recovery circuit timing based upon the automatic power control level determined by the load ratio.

13. The energy recovery circuit timing control method of claim 12, wherein, controlling power includes increasing the rising time of the sustain pulse waveform for the purpose of reducing the quantity of light by adjusting the energy recovery circuit timing in a predetermined area where the automatic power control level corresponding to the load ratio is below a predetermined value.
